(19) United States
(12) Patent Application Publication
(10) Pub. No.: US 2016/0125632 A1
(43) Pub. Date: May 5, 2016

(54) ELECTRONIC DEVICE AND METHOD FOR CREATING COMIC STRIP

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: Chih-Ping YU, New Taipei (TW); Chang-Fong LUNG, New Taipei (TW); Yi-Chun CHOU, New Taipei (TW); Sz-Han TSAI, New Taipei (TW)

(21) Appl. No.: 14/725,779

(22) Filed: May 29, 2015

(30) Foreign Application Priority Data
Oct. 31, 2014 (CN) 201410598328.8

(51) Int. Cl. G06T 11/60; G06T 3/40; G06F 17/21; G06F 17/24; G06F 3/0484; G06F 3/0482

(52) U.S. Cl. CPC G06T 11/60; G06F 3/04842; G06F 3/0482; G06F 17/212; G06F 17/248; G06T 3/40; G06T 2200/24

(57) ABSTRACT

A method for creating a comic strip includes selecting a background image from a number of background images for a number of comic cells of the comic strip, selecting a character from a number of characters to appear in the comic cells, selecting a character expression from a number of character expressions for the character to make, inputting text speech corresponding to the at least one character, and inputting audio for the character to speak. The comic cells can include different background images and different characters. The comic strip can be created by one user or a number of users.

### FIELD

The subject matter herein generally relates to comic creation, and more particularly to an electronic device and a method for creating a comic strip by one user or a plurality of users.

### BACKGROUND

Generally, comic strips are created by people who have skill in drawing. An electronic device and method for easily creating comic strips is desired for people who enjoy comic strips but have limited artistic ability. In addition, modern instant messaging platforms lack sufficient ability for users to graphically communicate and express themselves.

### BRIEF DESCRIPTION OF THE DRAWINGS

Implementations of the present technology will now be described, by way of example only, with reference to the attached figures.

FIG. 1 is a block diagram of an embodiment of an electronic device including a comic creation system for creating a comic strip.

FIG. 2 is a block diagram of an embodiment of function modules of the comic creation system of FIG. 1

FIG. 3 is a diagrammatic diagram of an embodiment of a virtual workspace for creating a comic strip including a plurality of comic cells.

FIG. 4 is a block diagram of each of the comic cells.

FIG. 5 is a diagrammatic diagram of an embodiment of a plurality of users creating a comic strip.

FIG. 6 is a block diagram of an embodiment of a storage unit of FIG. 1.

FIG. 7 is a diagrammatic diagram of an embodiment of a comic file created from a plurality of comic cells selected by a user.

FIG. 8 is a flowchart of a method for creating the comic strip.

FIG. 9 is a flowchart of a method for creating the comic file.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules can be embedded in firmware such as in an erasable-programmable read-only memory (EPROM). It will be appreciated that the modules can comprise connected logic units, such as gates and flip-flops, and can comprise programmable units, such as programmable gate arrays or processors. The modules described herein can be implemented as either software and/or hardware modules and can be stored in any type of computer-readable medium or other computer storage device.

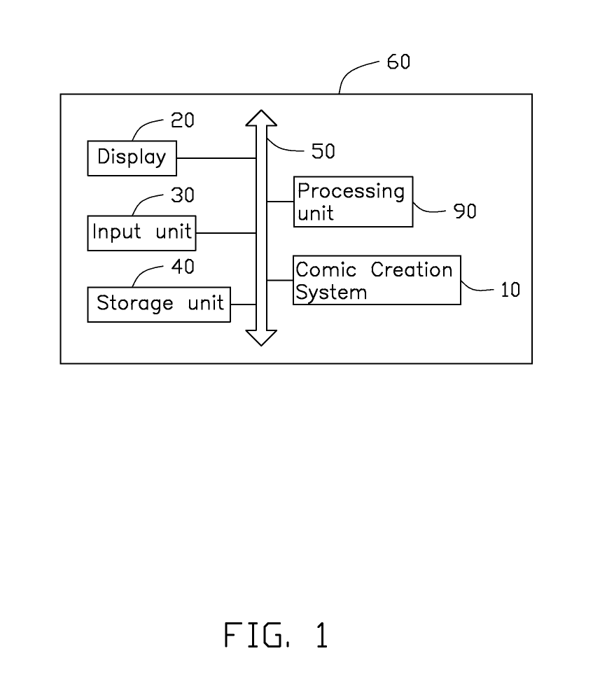

FIG. 1 illustrates an embodiment of an electronic device 60 for creating a comic strip. The electronic device 60 can include a display 20, an input unit 30, a storage unit 40, a processing unit 90, and a comic creation system 10. The display 20 can be used to display a virtual workspace thereon for creating the comic strip. The input unit 30 can be a touch screen of the electronic device 60, a mouse or keyboard of the electronic device 60, or the like. In at least one embodiment, the electronic device 60 can be a mobile phone or a computer tablet, for example.

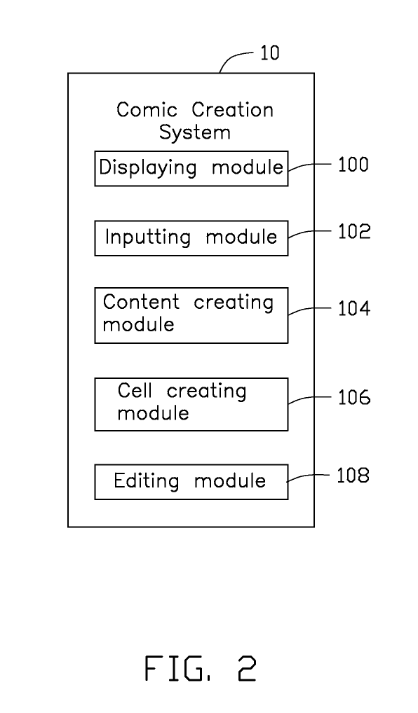

Referring to FIG. 2, the comic creation system 10 can include a plurality of modules, such as a displaying module 100, an inputting module 102, a content creating module 104, a cell creating module 106, and an editing module 108. The modules 100-108 can include one or more software programs in the form of computerized codes stored in the storage unit 40. The computerized codes can include instructions executed by the processing unit 90 to provide functions for the modules 100-108.

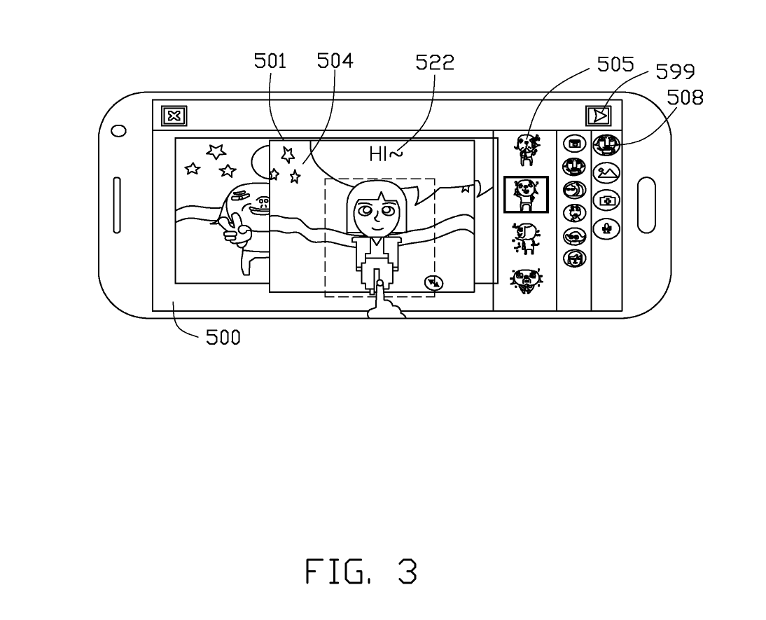

Referring to FIG. 3, the displaying module 100 can display a virtual workspace 500 on the display 20 for creating the comic strip. The comic strip can be composed of a plurality of comic cells 501. Each comic cell 501 can include a plurality of components, such as a background image 504 and a character 508. The inputting module 102 can receive user input from the input unit 30 throughout a process of creating the comic strip. To create a new comic cell 501, a user can select one background image 504 and at least one character 508. The background image 504 can be selected from a plurality of background images 504, and the character 508 can be selected from a plurality of characters 508. Each character 508 can include a plurality of character expressions 505. The user can select one of the character expressions 505 for the character 508 to make. The components of the comic cell 501 can further include text speech 522 corresponding to the character 508 input by the user. In at least one embodiment, the background image 504 is displayed to fit a size dimension of the comic cell 501, and the character 508 and the text speech 522 are displayed in predetermined positions of the comic cell 501. For example, in at least one embodiment, when the comic cell 501 is composed of only one character 508, the character 508 is displayed in a middle portion of the comic cell 504, and the text speech 522 is displayed in a position of the comic cell 501 located a distance ⅙ of a height of the comic cell 504 away from a top edge of the comic cell 501. In another embodiment, positions of the character 508 and the text speech 522 can be set by the user. When the comic cell 501 is finished being composed, the user can touch a finish button 599 of the virtual workspace 500.

In at least one embodiment, the character 508 and the background image 504 can be preset by the comic creation system 10. In another embodiment, the background image 504 and the character 508 can be captured by a camera such, as a camera module (not shown) of the electronic device 60, drawn, or taken from another source. The background image 504 can be a still image or a moving image.

In at least one embodiment, the comic cells 501 of the comic strip are created in sequence from a first comic cell 501 to a last comic cell 501. In at least one embodiment, the first comic cell 501 is a template selected from a plurality of templates (not shown). Each template is composed of a default background image 504 and a default number of characters 508. Each character 508 in the template can make a default character expression 505.

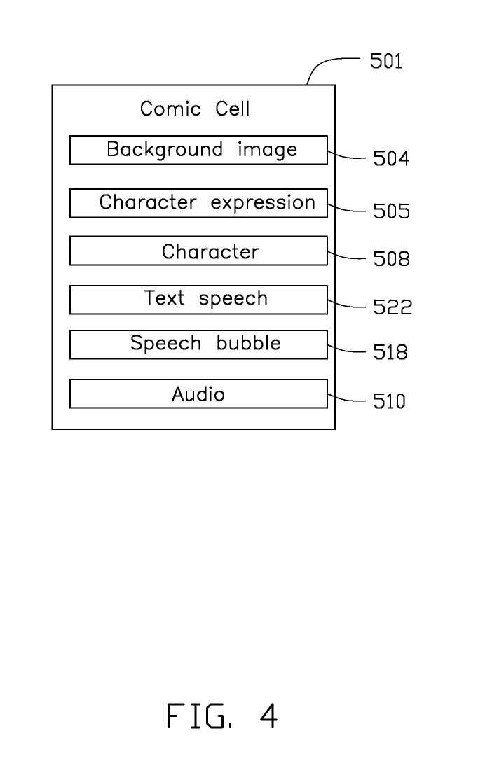

Referring to FIG. 4, the components of the comic cell 501 can further include an audio 510. The audio 510 can be spoken by the character 508 and can be recorded by a user through a microphone function of the electronic device 60. The audio 510 can also be taken from another source. The text speech 522 can further be received inside a speech bubble 518. A type of the speech bubble 518 can be selected from a plurality of speech bubble types.

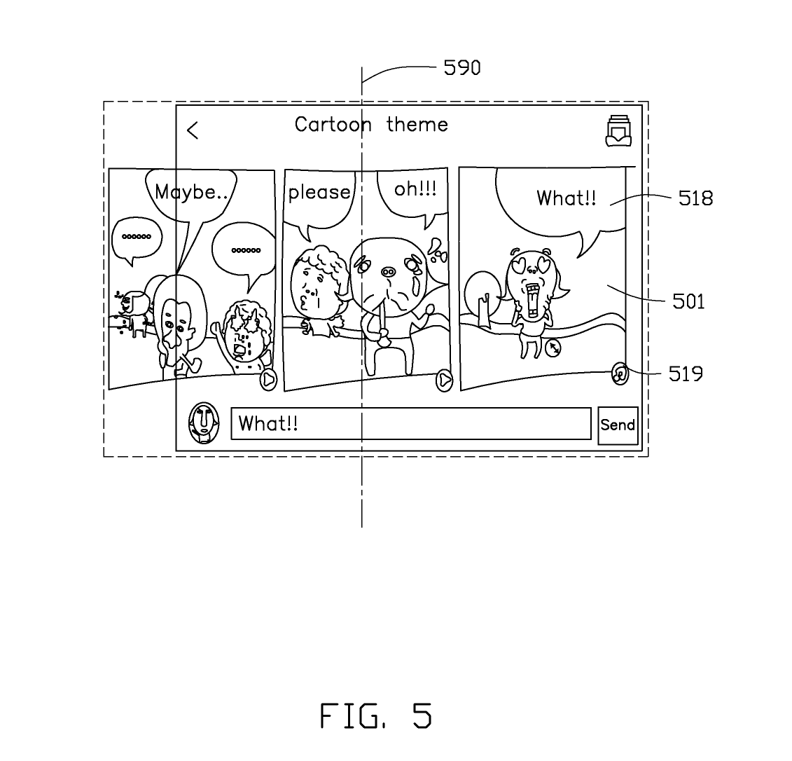

Referring to FIG. 5, in at least one embodiment, the comic strip can be created by a plurality of users each accessing the virtual workspace 500 through a corresponding electronic device 60 implementing the comic creation system 10. Each comic cell 501 can be created by a plurality of users. For example, one user can select a first character 508 and input first text speech 522 corresponding to the first character 508, and another user can select a second character 508 and input second text speech 522 corresponding to the second character 508. Thus, each character 508 can correspond to one user. The audio 510 of each comic cell 501 can be played when a position of the comic cell 501 in the virtual workspace 500 crosses a middle line 590 of the virtual workspace 500. In at least one embodiment, when the comic cell 501 is composed of a plurality of characters 508 each speaking a corresponding audio 510, the comic cell 501 plays the audios 510 in a predetermined sequence. In another embodiment, a sequence of playing the audios 510 can be set by a user. The comic cell 501 can comprise an audio button 519 that changes form when the audio 510 is played.

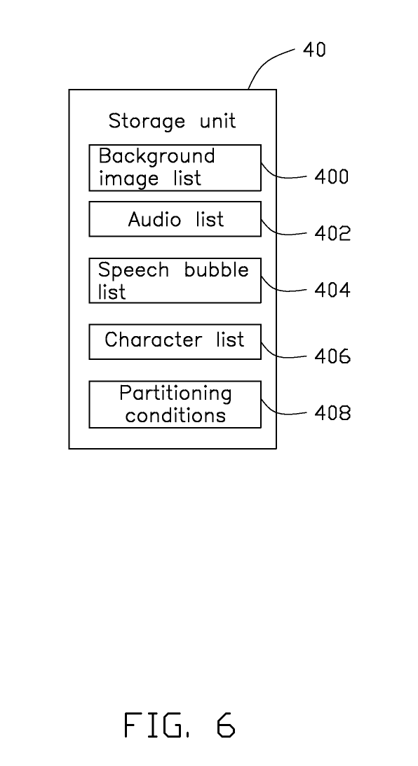

Referring to FIG. 6, the storage unit 40 can include a background image list 400 for storing the plurality of background images 504, an audio list 402 for storing the plurality of audios 510, a speech bubble list 404 for storing the plurality of speech bubble types, a character list 406 for storing the plurality of character 508 and the corresponding plurality of character expressions 505, and a plurality of partitioning conditions 408. The partitioning conditions 408 are conditions for automatically ending operations on a current comic cell 501 and opening a new comic cell 501. In at least one embodiment, the partitioning conditions 408 include the following: the background image 504 of the current comic cell 501 is changed to a different background image 504, the character 508 already present in the current comic cell 501 is selected again, and a predetermined amount of time passes without any changes made to the current comic cell 501. For example, FIG. 5 shows the user corresponding to one of the characters 508 already present in the current comic cell 501. Because the character 508 is already present in the current comic cell 501, a new comic cell is created according to the partitioning conditions to show the same character 508 speaking the text inputted by the user. A new comic cell 501 can also be manually created by a user.

In at least one embodiment, each of the plurality of components of the comic cell 501 corresponds to a component script. For example, each background image 504 is stored in the background image list 400 as a background image script, each audio 510 is stored in the audio list 402 as an audio script, each speech bubble type is stored in the speech bubble list 404 as a speech bubble script, each character 508 is stored in the character list 406 as a character script, and each character expression 505 is stored in the character list 406 as a character expression script. In this way, when the comic strip is saved, each comic cell 501 is not saved as a total image. Instead, each comic cell 501 is saved as the plurality of component scripts. Each component script can include information about the component in the comic cell 501, such as a position of the character 508 in the comic cell 501, a position of the speech bubble, speech text of the speech bubble, and contents of the audio 510. Thus, less storage space is required for saving the comic cells 501. The comic cells 501 can also be saved in a cloud storage (not shown) as the plurality of component scripts.

When creating the comic cell 501, the content creating module 104 can retrieve the corresponding component scripts from the storage unit 40 according to the user input received from the inputting module 102. The cell creating module 106 can create the comic cell 501 according to the component scripts.

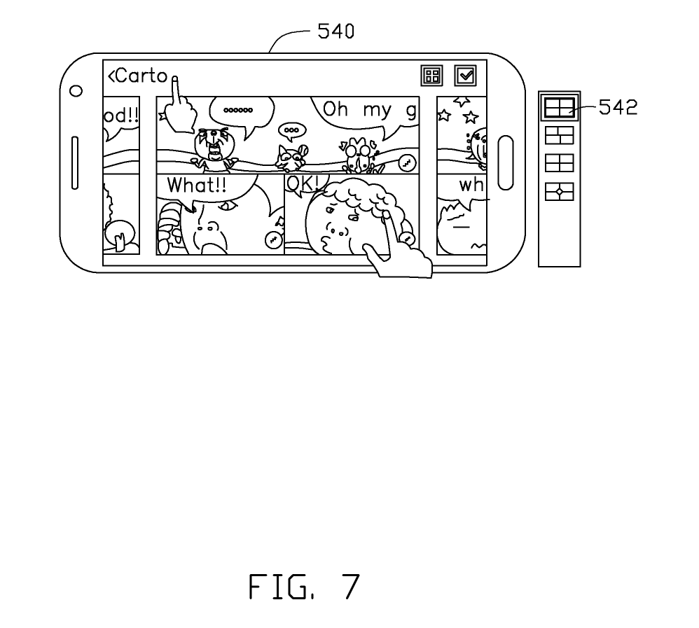

Referring to FIG. 7, one or more comic cells 501 can be selected by a user to be saved as a comic file 540. The editing module 108 can allow a user to select one or more comic cells 501 of the comic strip to be saved as a comic file, and edit the plurality of contents of the selected comic cells 501. In at least one embodiment, the one or more comic cells 501 can be editable by changing the background image 504, changing the characters 508 or a position of the characters 508 in the comic cell 501, changing the character expressions 505, changing the text speech 522, changing the speech bubble type, changing the audios 510, changing an order of the comic cells 501 in the comic file, changing a size of the characters 508, changing a size of the comic cells 501, and changing a display format 542 of the comic file 540.

By using the comic creation system 10, a user can easily create a comic strip using the plurality of components saved in the storage unit 40. In addition, when a plurality of users creates a comic strip, the users can be able to communicate with each other and express themselves more graphically through the comic strips. Any number of comic cells 501 created by a single user or by a plurality of users can be edited and saved as a comic file 540.

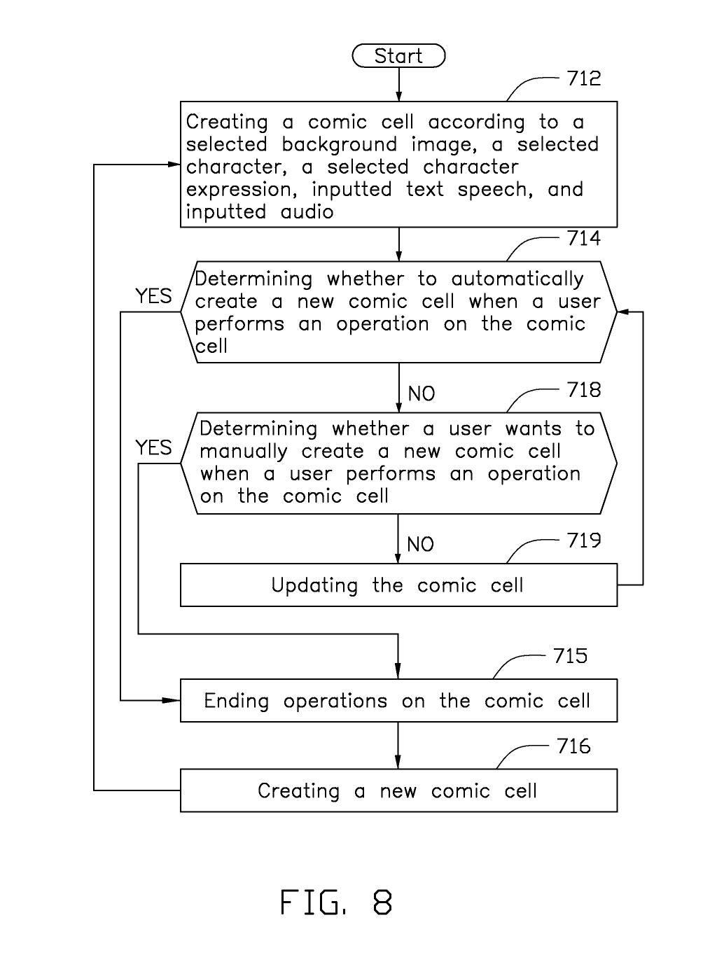

FIG. 8 illustrates a flowchart of an exemplary method for creating a comic strip. The example method is provided by way of example, as there are a variety of ways to carry out the method. The method described below can be carried out using the configurations illustrated in FIGS. 1-7, for example, and various elements of these figures are referenced in explaining the example method. Each block shown in FIG. 8 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 712.

At block 712, a comic cell can be created according to a selected background image, a selected character, a selected character expression, inputted text speech, and inputted audio. The background image can be selected from a plurality of background images, the character can be selected from a plurality of characters, and the character expression can be selected from a plurality of character expressions. Positions of the character and the text speech in the comic cell can be predetermined or set by a user. The comic cell can be created by one user or a plurality of users, each user selecting a corresponding character.

At block 714, whether to automatically create a new comic cell when a user performs an operation on the comic cell can be determined. A new comic cell can be created when one of a plurality of partitioning conditions is met. In at least one embodiment, the plurality of partitioning conditions can comprise the following: the background image of the comic cell is changed to a different background image, one of the characters already present in the comic cell is selected again, and a predetermined amount of time passes without any changes made to the comic cell. When automatic creation of a new comic cell is determined, block 715 is implemented. Otherwise, block 718 is implemented.

At block 718, whether a user wants to manually create a new comic cell when the user performs an operation on the comic cell can be determined. When user input is received to create a new comic cell, block 715 is implemented. When no user input to create a new comic cell is received and the user performs an operation on the comic cell, block 719 is implemented.

At block 719, the comic cell can be updated in response to the user's operation on the comic cell. For example, a new character or new text speech can be added to the comic cell, or an audio can be added to the comic cell.

At block 715, operations on the comic cell can be ended.

At block 716, a new comic cell can be created.

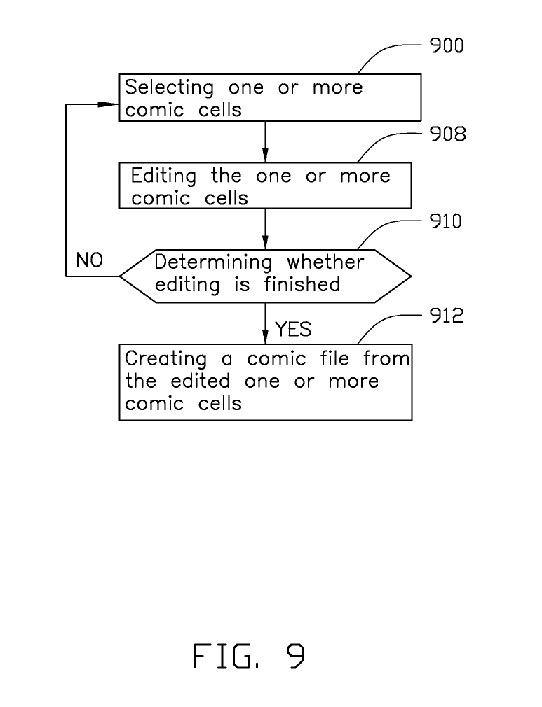

FIG. 9 illustrates a flowchart of an exemplary method for creating a comic file from a plurality of comic cells of a comic strip. The example method is provided by way of example, as there are a variety of ways to carry out the method. The method described below can be carried out using the configurations illustrated in FIGS. 1-7, for example, and various elements of these figures are referenced in explaining the example method. Each block shown in FIG. 9 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 900.

At block 900, a user can select one or more comic cells to be saved as a comic file.

At block 908, the user can edit the one or more comic cells. In at least one embodiment, the one or more cells selected to be saved as a comic file are editable by changing a background image of the comic cells, changing characters or a position of the characters in the comic cells, changing character expressions of the characters, changing text speech of the characters, changing speech bubble types of the text speech, changing audios spoken by the characters, changing an order of the comic cells of the comic file, changing a size of the characters and a size of the speech bubbles, changing a size of the comic cells, and changing a display format of the comic file.

At block 910, whether editing is finished can be determined. When user input is received to indicate that editing is not finished, block 900 is implemented. When user input is received to indicate that editing is finished, block 912 is implemented.

At block 912, the comic file is created from the edited one or more comic cells.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. A method for creating a comic strip composed of a plurality of comic cells, the method comprising:
displaying a virtual workspace on an interface of an electronic device, the virtual workspace configured to display the plurality of comic cells therein, wherein the interface can be accessed by one or more electronic devices each capable of creating the comic strip;
for each comic cell, selecting a background image of a plurality of background images, at least one character from a plurality of characters, and a character expression from a plurality of character expressions for the at least one character to make, and inputting text speech corresponding to the at least one character;
creating the comic cell comprising the background image, the at least one character making the character expression, and the text speech, the text speech being displayed in one of a plurality of types of speech bubbles, a type of the speech bubble being selected; and
saving one or more comic cells of the comic strip selected by a user as a comic file, the selected one or more comic cells being displayed in the comic file according to a display format selected from a plurality of display formats;
wherein the plurality of comic cells is created in sequence from a first comic cell to a last comic cell; and
wherein a new cell is created either manually or according to at least one of a plurality of preset partitioning conditions.

2. The method as in claim 1, wherein the plurality of background images, the plurality of characters, the plurality of character expressions, and the plurality of speech bubble types are preset or created by a user.

3. The method as in claim 2, wherein the plurality of background images, the plurality of characters, the plurality of character expressions, and the plurality of speech bubble types are created by a user by being captured by a camera, being drawn by the user, or being taken from another source.

4. The method as in claim 1, wherein the first comic cell is created by selecting a template from a plurality of templates; each template comprises a default background image and a default number of characters; and each character is a default character making a default character expression.

5. The method as in claim 1 further comprising inputting an audio for the at least one character to speak.

6. The method as in claim 5, wherein the audio spoken by the at least one character is recorded by a user or taken from another source; and comic cells comprising two or more characters that speak an audio play the audios in a default sequence or in a sequence set by a user.

7. The method as in claim 1, wherein the plurality of preset partitioning conditions comprises:
a background image that is different from the background image in a current comic cell is selected;
a character that is in the current comic cell is selected again; and
a predetermined amount of time passes without any changes made to the current comic cell.

8. The method as in claim 1, wherein a size of the background image is automatically adjusted to fit a size dimension of the comic cell; the at least one character is automatically displayed in a default position of the comic cell; the speech bubble is automatically displayed in a default position of the comic cell; and a display position of the at least one character and the speech bubble is able to be set by a user.

9. The method as in claim 1, wherein:
the one or more cells selected to be saved as a comic file are editable by changing the background image, changing the characters or a position of the characters in the cell, changing the character expressions, changing the text speech, changing the speech bubble type, changing the audios, changing an order of the comic cells of the comic file, changing a size of the characters and a size of the speech bubbles, changing a size of the comic cells, and changing the display format of the comic file.

10. The method as in claim 1, wherein for each comic cell of the comic strip, each of the background images, each of the characters, each of the character expressions, each of the speech bubbles with the corresponding text speech, and each of the audios are saved in the electronic device as a corresponding background image script, a corresponding character script, a corresponding character expression script, a corresponding speech bubble script, and a corresponding audio script, respectively; each comic cell of the comic strip is created according to the corresponding scripts; each comic cell of the comic strip is saved in at least one of the electronic device and a cloud storage as the corresponding scripts; information of the background image scripts, the character scripts, and the speech bubble scripts comprises positions of the comic cell for displaying the background image, the characters, and the speech bubbles; and information of the speech bubble scripts and the audio scripts comprises contents of the audios and contents of the speech bubbles.

11. An electronic device for creating a comic strip, the electronic device comprising:
a display configured to display a virtual workspace therein for creating the comic strip;
an input unit configured to receive user input for creating the comic strip;
a storage unit configured to store a plurality of components for composing the comic strip, and further storing a plurality of instructions of a plurality of modules of a comic creation system for creating the comic strip; and
a processing unit configured to execute the plurality of instructions of the plurality of modules of the comic creation system;
wherein the virtual workspace is accessible by a plurality of electronic devices each implementing the comic creation system and each capable of creating the comic strip;
wherein each comic cell is composed of components of the plurality of components selected by one user or a plurality of users through the corresponding electronic devices;
wherein the plurality of comic cells is created in sequence from a first comic cell to a last comic cell; and
wherein a new cell is created either manually or according to at least one of a plurality of preset partitioning conditions stored in the storage unit.

12. The electronic device as in claim 11, wherein the plurality of components comprises:
a plurality of background images;
a plurality of characters;
a plurality of character expressions for each of the plurality of characters to make; and
a plurality of speech bubble types;
wherein the comic cells are composed of at least one background image, at least one character making at least one character expression, and at least one speech bubble corresponding to the at least one character and comprising speech text inputted through the input unit.

13. The electronic device as in claim 12, wherein the first comic cell is created by selecting a template from a plurality of templates; each template comprises a default background image and a default number of characters; and each character is a default character making a default character expression.

14. The electronic device as in claim 12, wherein the plurality of background images, the plurality of characters, the plurality of character expressions, and the plurality of speech bubble types are preset or created by a user.

15. The electronic device as in claim 14, wherein the plurality of background images, the plurality of characters, the plurality of character expressions, and the plurality of speech bubble types are created by a user by being captured by a camera, being drawn by the user, or being taken from another source.

16. The electronic device as in claim 12, wherein the plurality of components further comprises a plurality of audios recorded by a user through a microphone function of the electronic device or taken from another source; and comic cells comprising two or more characters that speak an audio play the audios in a default sequence or in a sequence set by a user.

17. The electronic device as in claim 16, wherein the comic cells that comprise audio are displayed with an audio button; when viewing the comic strip, the audio of one of the comic cells is automatically played when the comic cell is displayed in a predetermined position of the virtual workspace; and the audio button changes form when the audio of the comic cell is played.

18. The electronic device as in claim 16, wherein:
the storage unit stores a background image list, an audio list, a speech bubble list, a character list, and the plurality of partitioning conditions;
each background image is stored in the background image list as a background image script;
each audio is stored in the audio list as an audio script;
each speech bubble type is stored in the speech bubble list as a speech bubble script;
each character is stored in the character list as a character script;
each character expression is stored in the character list as a character expression script;
each comic cell of the comic strip is created according to the corresponding scripts;
each comic cell of the comic strip is saved in at least one of the electronic device and a cloud storage as the corresponding scripts;
information of the background image scripts, the character scripts, and the speech bubble scripts comprises positions of the comic cell for displaying the background image, the characters, and the speech bubbles; and information of the speech bubble scripts and the audio scripts comprises contents of the audios and contents of the speech bubbles.

19. The electronic device as in claim 18, wherein the plurality of modules of the comic creation system comprises:
a displaying module configured to display the virtual workspace and the comic strip on the display;
an inputting module configured to receive the user input from the input unit;
a content creating module configured to retrieve the corresponding scripts in response to a user's input;
a cell creating module configured to create the comic cell according to the corresponding scripts; and
an editing module configured to allow a user to edit the plurality of contents of one or more comic cells of the comic strip selected by a user to be saved as a comic file;
wherein the storage unit saves each comic cell of the comic strip as the corresponding scripts; and
the scripts of each cell comprise information about a position of the comic cell where the corresponding component is displayed.

20. The electronic device as in claim 19, wherein:
each of the plurality of contents of each comic cell selected by the user to be saved as a comic file is editable through the editing module;
the one or more cells selected to be saved as a comic file are editable by changing the background image, changing the characters or a position of the characters in the cell, changing the character expressions, changing the text speech, changing the speech bubble type, changing the audios, changing an order of the comic cells of the comic file, changing a size of the characters and a size of the speech bubbles, changing a size of the comic cells, and changing a display format of the comic file.
